(19) United States
(12) Patent Application Publication
(10) Pub. No.: US 2025/0306289 A1
(43) Pub. Date: Oct. 2, 2025

(54) FIBER OPTIC CIRCUIT AND PREPARATION METHOD

(71) Applicant: COMMSCOPE TECHNOLOGIES LLC, Claremont, NC (US)

(72) Inventors: Thomas MARCOUILLER, Shakopee, MN (US); Paula LOCKHART, New Prague, MN (US); Wouter VRANKEN, Testelt (BE); Koen VUERINCKX, Holsbeek (BE); Laurens Izaäk VAN WUIJCKHUIJSE, Eden Prairie, MN (US)

(73) Assignee: COMMSCOPE TECHNOLOGIES LLC, Claremont, NC (US)

(21) Appl. No.: 19/089,301

(22) Filed: Mar. 25, 2025

Related U.S. Application Data
(63) Continuation of application No. 18/185,795, filed on Mar. 17, 2023, now Pat. No. 12,276,858.
Application No. 18/185,795 is a continuation of application No. 17/855,153, filed on Jun. 30, 2022, now Pat. No. 11,609,400.
Application No. 17/855,153 is a continuation of application No. 16/753,268, filed on Apr. 2, 2020, now Pat. No. 11,409,068.
(60) Provisional application No. 62/566,906, filed on Oct. 2, 2017.

(51) Int. Cl. G02B 6/36; G02B 6/44

(52) U.S. Cl. CPC G02B 6/3608; G02B 6/3652; G02B 6/3684; G02B 6/4403; G02B 6/4471; G02B 6/44715; G02B 6/448

(57) ABSTRACT

A method of preparing a preformed fiber optic circuit for later termination to at least one fiber optic connector includes providing a substrate for supporting a plurality of optical fibers, the substrate including at least one layer of flexible foil, wherein the flexible foil may be formed from polyethylene terephthalate (PET) according to one example and peeling a layer including at least the optical fibers from the at least one layer of flexible foil.

### CROSS-REFERENCE TO RELATED APPLICATION

This application is a Continuation of U.S. patent application Ser. No. 18/185,795, filed on Mar. 17, 2023; which is a Continuation of U.S. patent application Ser. No. 17/855,153, filed on Jun. 30, 2022, now U.S. Pat. No. 11,609,400; which is a Continuation of U.S. patent application Ser. No. 16/753,268, filed on Apr. 2, 2020, now U.S. Pat. No. 11,409,068; which is a National Stage Application of PCT/US2018/053935, filed on Oct. 2, 2018; which claims the benefit of U.S. Patent Application Ser. No. 62/566,906, filed on Oct. 2, 2017, the disclosures of which are incorporated herein by reference in their entireties. To the extent appropriate, a claim of priority is made to each of the above disclosed applications.

### BACKGROUND

As demand for telecommunications increases, fiber optic networks are being extended in more and more areas. In dense environments, ease of installation, accessibility, and serviceability of the optical fibers within the equipment are important concerns. As a result, there is a need for fiber optic devices which address these and other concerns.

### SUMMARY

An aspect of the present disclosure relates to fiber optic circuits, specifically, preformed optical circuits, wherein the fibers are disposed in a predetermined orientation/layout ready for termination to fiber optic connectors. Such fiber optic circuits may be carried within devices, for example, in the form of fiber optic cassettes. Such cassettes may house at least one connector terminated to the preformed circuit that provides a signal entry location and at least one connector terminated to an opposite end of the preformed circuit that provides a signal exit location, wherein the fiber optic circuit is positioned within an interior of the cassette for relaying the signal from the entry location to the exit location. The optical circuits of the present disclosure, as well as the equipment the circuits are housed in, can have many forms. A cassette is simply one example piece of fiber optic equipment for housing such preformed optical circuits.

Another aspect of the present disclosure relates to a method of preparing a preformed fiber optic circuit, the method comprising providing a substrate for supporting a plurality of optical fibers, the substrate including at least one layer of flexible foil and peeling a layer including at least the optical fibers from the at least one layer of flexible foil.

According to another aspect of the disclosure, the preformed fiber optic circuit that is configured for termination to at least one fiber optic connector can include a plurality of optical fibers arranged in a predetermined arrangement, wherein at least a portion of the optical fibers are supported by a layer of flexible foil and at least a portion are coated by a coating including silicone.

According to another aspect of the disclosure, the preformed fiber optic circuit that is configured for termination to at least one fiber optic connector can include a plurality of optical fibers arranged in a predetermined arrangement, wherein at least portion of the optical fibers are supported by a layer of flexible foil, wherein the portion supported by the layer of flexible foil is at least partially coated by a coating including silicone, wherein the plurality of optical fibers also includes at least a portion not supported by a layer of flexible foil and not coated by a coating including silicone.

A variety of additional inventive aspects will be set forth in the description that follows. The inventive aspects can relate to individual features and combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a top, front, right side perspective view of an example fiber optic cassette that is shown to house a flexible fiber optic circuit, the fiber optic cassette also being usable with the inventive preformed fiber optic circuits of the present disclosure.

FIG. 2 illustrates the fiber optic cassette of FIG. 1 in an exploded configuration.

FIG. 3 is a perspective view of an example flexible fiber optic circuit that transitions two multi-fiber connectors to three multi-fiber connectors and that includes dark fibers.

FIG. 4 is a top view of the flexible fiber optic circuit of FIG. 3.

FIG. 5 is an enlarged view of a portion of the flexible fiber optic circuit of FIG. 3, showing the placement of the dark fibers.

FIG. 6 shows another close up view of an example circuit transitioning fibers from two twelve-fiber connectors to three twelve-fiber connectors, further illustrating the dark fibers.

FIG. 7 illustrates an example of a preformed fiber optic circuit transitioning two sets of twelve fibers to three sets of eight fibers, the preformed circuit having features that are examples of inventive aspects in accordance with the present disclosure, wherein the preformed fiber optic circuit can be utilized within a fiber optic cassette such as that shown in FIGS. 1-2.

FIG. 8 shows an enlarged view of a first end of the preformed fiber optic circuit of FIG. 7, illustrating the two sets of twelve fibers that are to be terminated to two multi-fiber connectors.

FIG. 9 shows an enlarged view of a second end of the preformed fiber optic circuit of FIG. 7, illustrating the three sets of twelve fibers that are to be terminated to three multi-fiber connectors, wherein four of the fibers for each multi-fiber connector are dummy or dark fibers, resulting in eight active fibers for each of the three multi-fiber connectors.

FIG. 10 illustrates another example of a preformed fiber optic circuit similar to that shown in FIGS. 7-9, but transitioning twenty-four fibers to three sets of eight fibers, the preformed circuit having features that are examples of inventive aspects in accordance with the present disclosure, wherein the preformed fiber optic circuit can be utilized within a fiber optic cassette such as that shown in FIGS. 1-2.

FIG. 11 shows an enlarged view of a first end of the preformed fiber optic circuit of FIG. 10, illustrating the twenty-four fibers that are to be terminated to a multi-fiber connector.

FIG. 12 shows an enlarged view of a second end of the preformed fiber optic circuit of FIG. 10, illustrating the three sets of twelve fibers that are to be terminated to three multi-fiber connectors, wherein four of the fibers for each multi-fiber connector are dummy or dark fibers, resulting in eight active fibers for each of the three multi-fiber connectors.

FIGS. 13-20 illustrate an example method of forming the preformed fiber optic circuits of the present disclosure, the method having features that are examples of inventive aspects in accordance with the present disclosure, the method of FIGS. 13-20 usable in forming the example circuits illustrated in FIGS. 7-12.

FIG. 21 illustrates at least a portion of the preformed fiber optic circuit prepared in accordance with the method illustrated in FIGS. 13-20, wherein the portion includes a plurality of fibers in a predetermined arrangement supported by a layer of polyethylene terephthalate (PET) foil and coated by a silicone coating.

FIG. 22 illustrates at least a portion of the preformed fiber optic circuit prepared in accordance with the method illustrated in FIGS. 13-20, wherein the portion includes a plurality of fibers in a predetermined arrangement coated by a silicone coating.

FIG. 23 illustrates at least a portion of the preformed fiber optic circuit prepared in accordance with the method illustrated in FIGS. 13-20, wherein the portion includes a plurality of fibers in a predetermined arrangement supported by a layer of PET foil.

FIG. 24 illustrates at least a portion of the preformed fiber optic circuit prepared in accordance with the method illustrated in FIGS. 13-20, wherein the portion includes the uncoated bare fibers separated from the PET foil of FIG. 23.

FIG. 25 illustrates a hybrid type fiber optic circuit prepared in accordance with the method illustrated in FIGS. 13-20, wherein first ends of the fibers of the circuit are terminated to simplex fiber optic connectors and second ends of the fibers of the circuit are terminated to a multi-fiber connector, wherein the portion of the fiber optic circuit adjacent the simplex fiber optic connectors includes a plurality of fibers in a predetermined arrangement supported a layer of PET foil and coated by a silicone coating, and wherein the portion of the fiber optic circuit adjacent the multi-fiber connector includes a plurality of uncoated bare stranded fibers in a predetermined arrangement.

### DETAILED DESCRIPTION

The present disclosure is directed generally to fiber optic circuits, specifically, preformed optical circuits, wherein the fibers are disposed in a predetermined orientation/layout ready for termination to fiber optic connectors. Such fiber optic circuits may be carried within devices, for example, in the form of fiber optic cassettes that include at least one connector that provides a signal entry location and at least one connector that provides a signal exit location, wherein the fiber optic circuit is positioned thereinbetween for relaying the signal from the entry location to the exit location.

The use of preformed circuits in accordance with the present disclosure can provide a number of advantages. For example, the use of a preformed circuit allows a designer or technician to fix the fibers in a given orientation, wherein the circuit layouts may be produced in a predictable and automated manner. Manual handling and positioning of the fibers within the equipment may be reduced and eliminated through the use of preformed optical circuits. Complexity of the circuits can be increased due to the pre-fixed positioning of the fibers. Termination of the fibers may be facilitated. Methods of the present disclosure that are used to pre-fix the fibers allow the designers to optimize fiber bend radius limits and requirements in configuring the equipment in which they are used, thus, achieving reduced dimensions for the equipment. The bend radius of the fibers can thus be controlled to a minimum diameter.

It should be noted that the optical circuits of the present disclosure, as well as the equipment the circuits are housed in, can have many forms. A cassette is simply one example piece of fiber optic equipment for housing such preformed optical circuits.

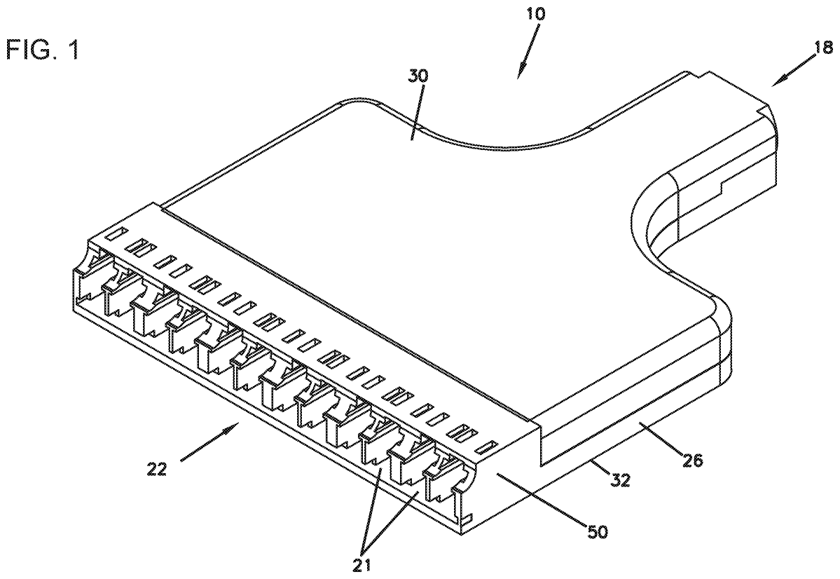

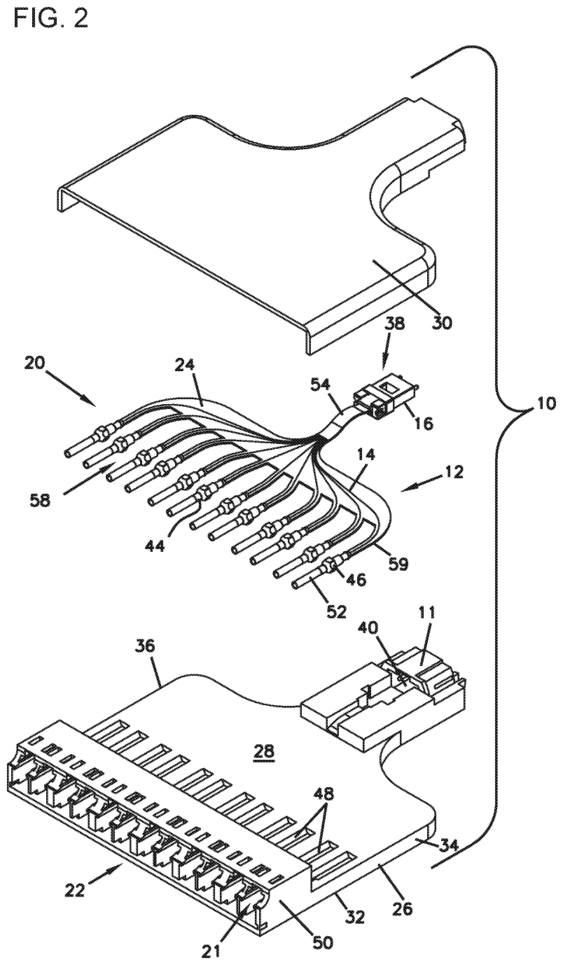

An example of a fiber optic cassette 10 that can utilize the inventive preformed fiber optic circuits of the present disclosure is shown in FIGS. 1-2. In FIG. 2, the cassette 10 is shown with a conventional flexible fiber optic circuit 12. The flexible fiber optic circuit 12 may be replaced with a preformed optical circuit prepared in accordance with the methods of the present disclosure to be discussed in further detail below.

In the fiber optic cassette 10 of FIGS. 1-2, the flexible optical circuit 12 is depicted as transitioning optical fibers 14 between a conventional connector 16 (e.g., an MPO connector) at a rear 18 of the cassette 10 and a plurality of non-conventional connectors 20 at an opposite front end 22 of the cassette 10, wherein portions of a substrate 24 of the flexible optical circuit 12 are physically inserted into the non-conventional connectors 20.

It should be noted that the term “non-conventional connector” may refer to a fiber optic connector that is not of a conventional type such as an LC or SC connector and one that has generally not become a recognizable standard footprint for fiber optic connectivity in the industry.

The elimination of conventional mating connectors inside the cassette 10 may significantly reduce the overall cost by eliminating the skilled labor normally associated with terminating an optical fiber to a connector, including polishing the end face of the fiber and epoxying the fiber into the connector. It further allows the fiber optic interconnect device such as the optical cassette 10 to be made very thin.

Still referring to FIGS. 1-2, the cassette 10 includes a body 26 defining the front 22, the rear 18, and an interior 28. The body 26 further includes a top 30, a bottom 32, and sides 34, 36.

A signal entry location 38 may be provided by the MPO connector 16, which, in the illustrated embodiment, is along the rear 18 of the cassette body 26. A pocket 40 seats an MPO adapter 11 for holding the MPO connector 16. Non-conventional connectors 20 are arranged linearly adjacent the front 22 of the cassette 10. In the depicted embodiment of the cassette 10, the MPO connector 16 of the cassette 10 is positioned to extend generally parallel to ferrules 44 of the non-conventional connectors 20 at the front 22 of the cassette 10.

In general, cassette 10 includes the top 30 and bottom 32 which are generally parallel to each other and define the major surfaces of cassette body 26. Sides 34, 36, front 22, and rear 18 generally define the minor sides of cassette body 26. The cassette 10 can be oriented in any position, so that the top and bottom surfaces can be reversed, or positioned vertically, or at some other orientation.

In the embodiment of the fiber optic cassette 10 shown in FIGS. 1-2, the non-conventional connectors 20 that are positioned adjacent the front 22 of the cassette 10 each define a hub 46 mounted over the ferrule 44. Each ferrule 44 is configured to terminate one of the fibers 14 extending out from the flexible circuit 12.

The non-conventional connectors 20 are placed within pockets 48 provided at a connection block or array 50 located at the front 22 of the cassette 10. A split sleeve 52 is also provided for ferrule alignment between the hub 46 and ferrule 44 of each non-conventional connector 20 and the ferrule of another mating connector that enters the cassette 10 from the front 22.

The mating connectors entering the cassette 10 from the front 22 of the cassette 10 may be connected through fiber optic adapters 21 that are mounted on the connection block 50. The adapters 21 at the front 22 of the cassette 10 allow conventional connectors such as LC connectors to be mated to the non-conventional connectors 20 located within the interior 28 of the cassette 10. Such adapters or adapter blocks may be snap-fit, ultrasonically welded, or otherwise attached to the rest of the cassette body 26. In the illustrated embodiment of the cassette 10 of FIGS. 1-2, the adapters that would be used with the cassette 10 are sized to receive mating LC connectors.

The cassette 10 of FIGS. 1-2 can be sealed or can be openable, so as to allow repair, or cleaning of the inner hubs 46 and ferrules 44. The flexible fiber optic circuit 12 may allow the entire fiber bundle, including the MPO connector 16 to be able to be removed for cleaning or replacement.

The fiber pigtails 14 extending out from a rear end 54 of the substrate 24 forming the flexible optical circuit 12 may be terminated to an MT ferrule of the MPO connector 16. The fiber pigtails 14 extending out from a front end 58 of the substrate 24 are individually terminated to the ferrules 44 to be positioned at the front 22 of the cassette 10. As shown, the substrate 24 defines front extensions 59 (one per fiber 14) each provided in a spaced apart configuration for providing some flexibility to the substrate 24. The individual fibers 14 are separated out from the ribbonized section at the rear 54 of the substrate 24 and are routed through the substrate 24 to the individual front extensions 59. By using a rigid substrate, when the fibers are being terminated to the ferrules 44, the ends of the fibers may be cleaved and ends of all of the ferrules 44 extending from the substrate 24 may be polished simultaneously.

As noted above, the cassette of FIGS. 1-2 is simply one example of a fiber optic cassette that can utilize the inventive preformed fiber optic circuits of the present disclosure. The flexible fiber optic circuit 12 of the cassette 10 may be replaced with a preformed optical circuit prepared in accordance with the methods of the present disclosure to be discussed in further detail below.

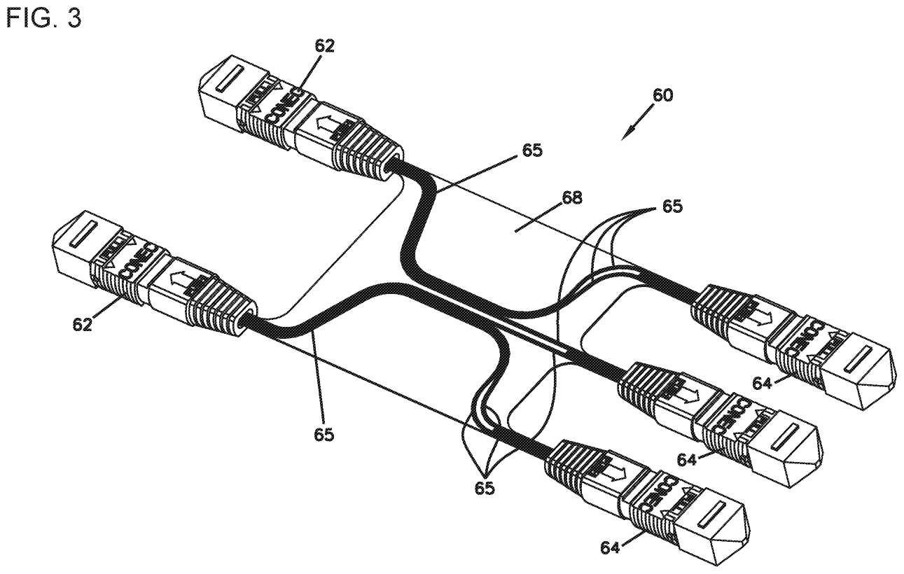

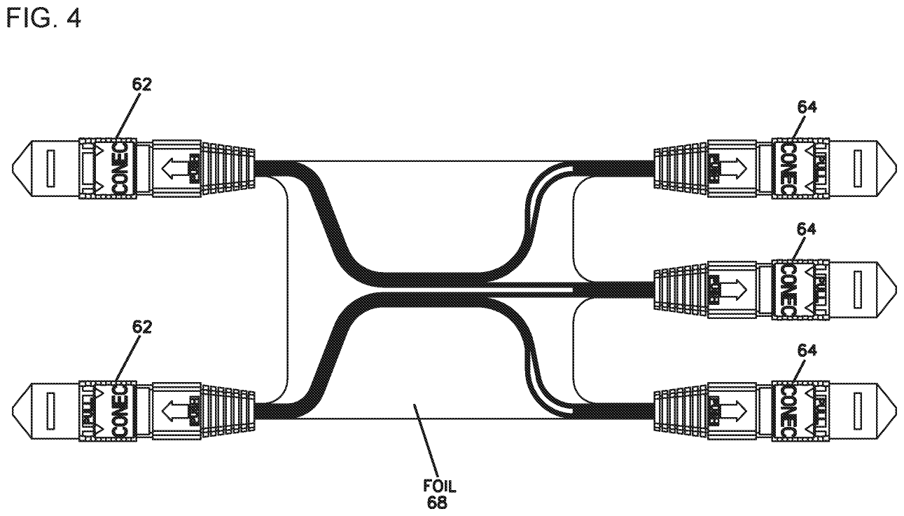

Referring now to FIGS. 3-6, another example of a conventional flexible fiber optic circuit 60 that transitions two multi-fiber connectors 62 to three multi-fiber connectors 64 and that includes dark fibers 66 is illustrated. It should be noted that such a flexible circuit is another example of a fiber circuit that can be replaced with a preformed optical circuit prepared in accordance with the methods of the present disclosure to be discussed in further detail below.

Still referring to FIGS. 3-6, in the illustrated example, a flex foil 68 is shown with multiple connectors 62, 64 connected to various fibers 65 organized and supported by the foil 68. As shown, not all of the fibers 65 provided carry signals. Specifically, on the side of the foil 68 with three connectors 64, only eight of the twelve fibers 65 carry signals, and the middle four, are dark fibers 66. If such unused fibers 66 were not present, there is a chance the multi-fiber ferrule could become damaged during polishing.

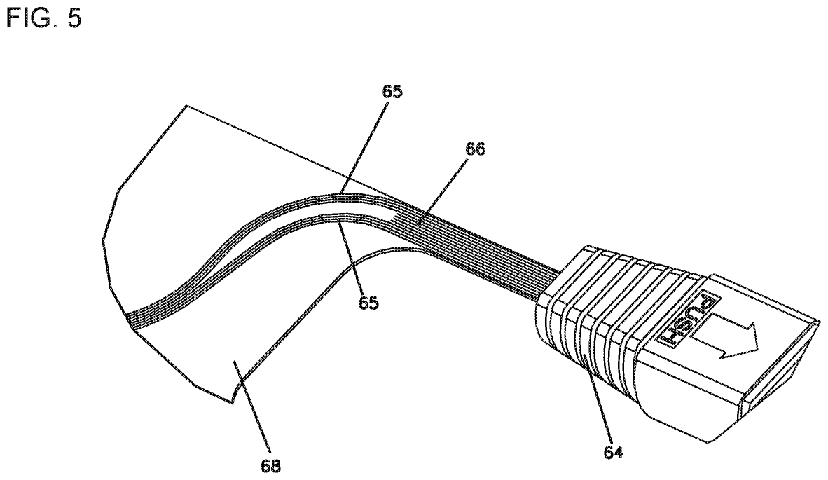

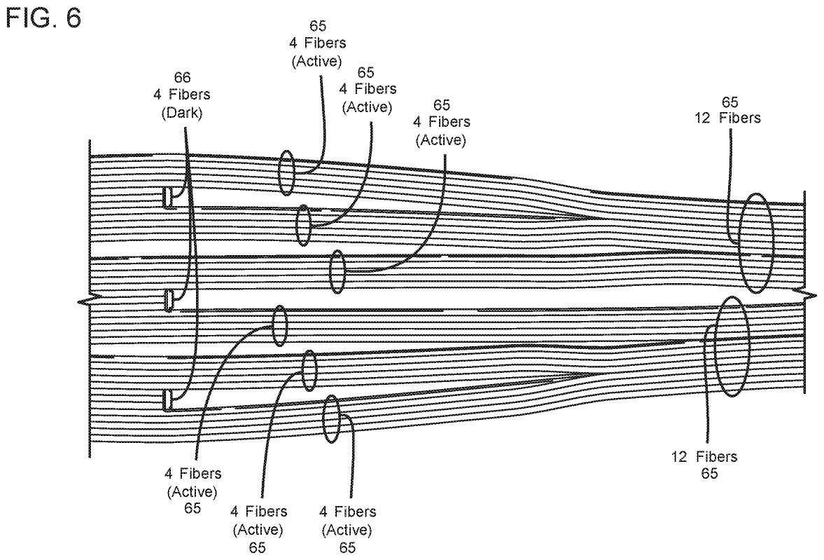

FIGS. 5-6 specifically provides close-up views illustrating the dark fibers 66 in the transition from the two twelve-fiber connectors 62 to three twelve-fiber connectors 64.

A fiber optic circuit such as the circuit 60 shown in FIGS. 3-6 can be utilized in a piece of fiber optic equipment such as a cassette similar to the cassette 10 of FIGS. 1-2 if the cassette is configured accordingly.

Referring now to FIGS. 7-9, an example of a preformed fiber optic circuit 100 transitioning two sets of twelve fibers 102 to three sets of eight fibers 102, the preformed circuit 100 having features that are examples of inventive aspects in accordance with the present disclosure, is illustrated. The preformed fiber optic circuit 100 can essentially replace the circuit 60 illustrated in FIGS. 3-6 and can be prepared in accordance with the methods of the present disclosure to be discussed in further detail below. As noted above, the preformed fiber optic circuit 100 of FIGS. 7-9 can be utilized within a fiber optic cassette such as the cassette 10 shown in FIGS. 1-2.

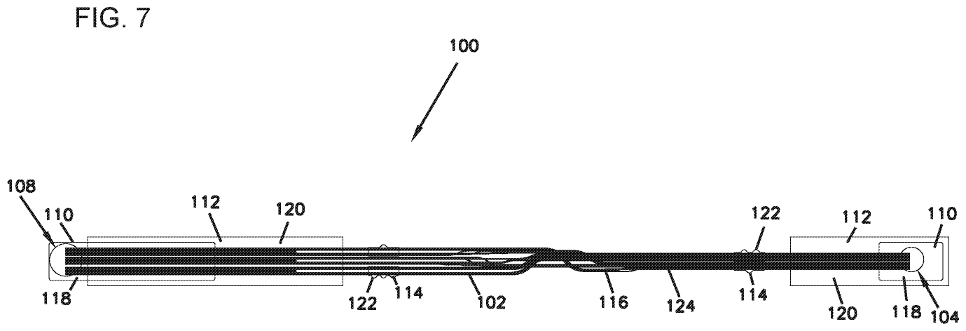

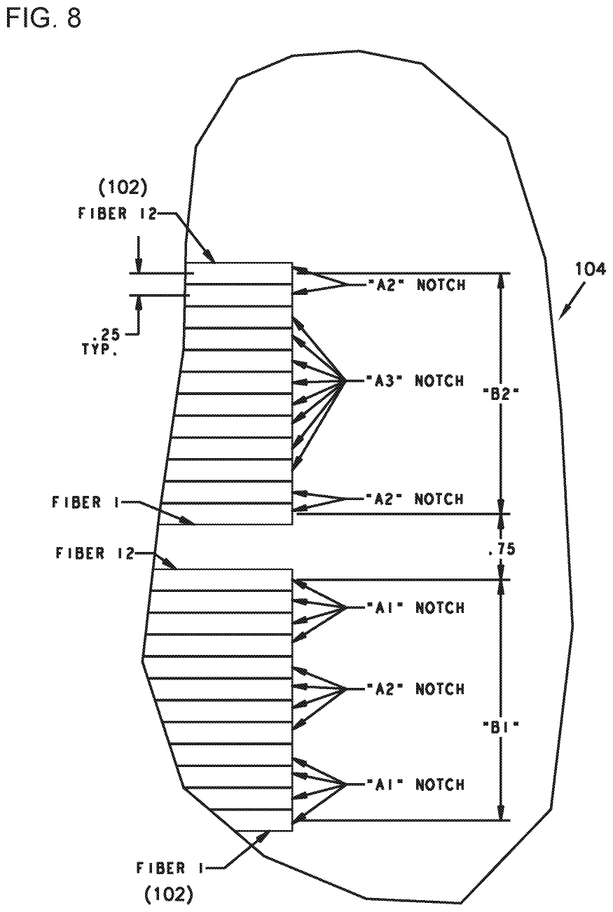

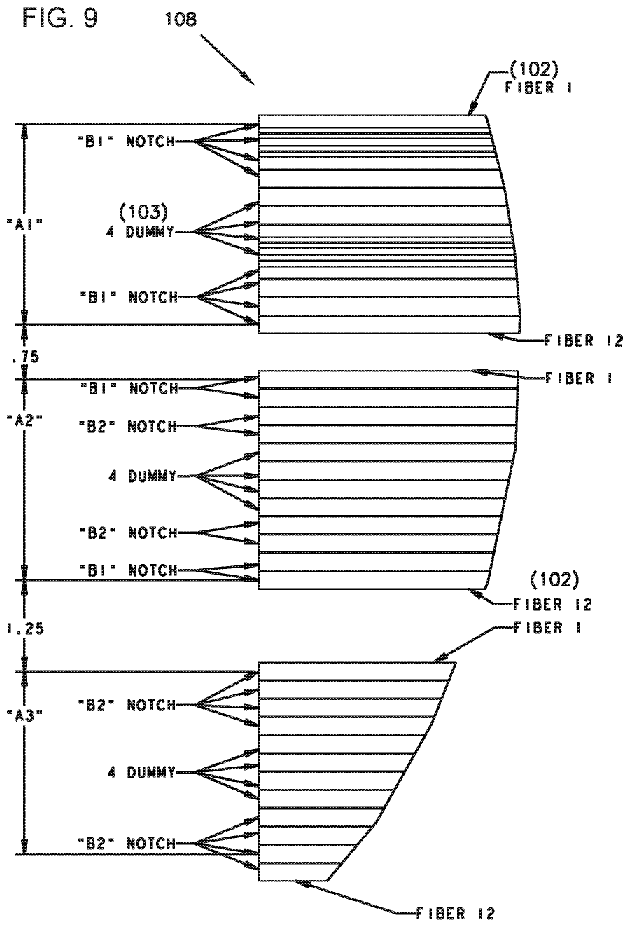

FIG. 8 shows an enlarged view of a first end 104 of the preformed fiber optic circuit 100 of FIG. 7, illustrating the two sets of twelve fibers 102 that are to be terminated to two multi-fiber connectors, and FIG. 9 shows an enlarged view of a second end 108 of the preformed fiber optic circuit 100 of FIG. 7, illustrating the three sets of twelve fibers 102 that are to be terminated to three multi-fiber connectors, wherein four of the fibers 102 for each multi-fiber connector are dummy or dark fibers 103, resulting in eight active fibers 102 for each of the three multi-fiber connectors.

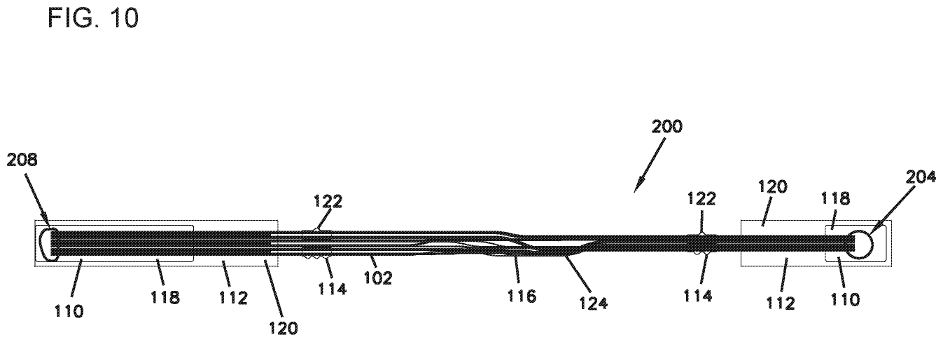

Referring now to FIGS. 10-12, another example of a preformed fiber optic circuit 200 similar to that shown in FIGS. 7-9, but transitioning twenty-four fibers 102 to three sets of eight fibers 102, the preformed circuit 200 having features that are examples of inventive aspects in accordance with the present disclosure, is illustrated. As noted above, the preformed fiber optic circuit 200 of FIGS. 10-12 can be utilized within a fiber optic cassette such as the cassette 10 shown in FIGS. 1-2.

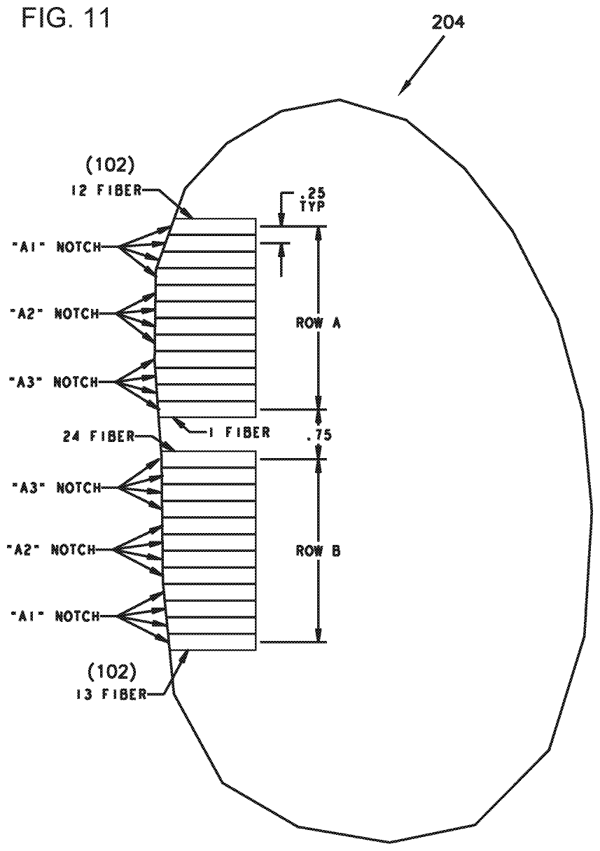

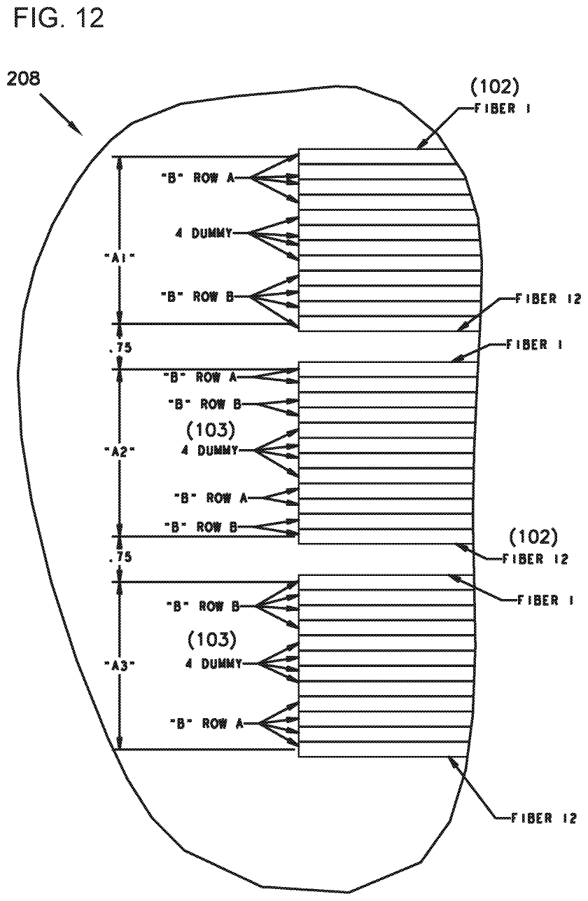

FIG. 11 shows an enlarged view of a first end 204 of the preformed fiber optic circuit 200 of FIG. 10, illustrating the twenty-four fibers 102 that are to be terminated to a multi-fiber connector, and FIG. 12 shows an enlarged view of a second end 208 of the preformed fiber optic circuit 200 of FIG. 10, illustrating the three sets of twelve fibers 102 that are to be terminated to three multi-fiber connectors, wherein four of the fibers for each multi-fiber connector are dummy or dark fibers 103, resulting in eight active fibers 102 for each of the three multi-fiber connectors.

Each of the preformed fiber optic circuits (100 of FIGS. 7-9 and 200 of FIGS. 10-12) includes a first portion 110, a second portion 112, a third portion 114, and a fourth portion 116. The first portion 110 can be referred to as a flex foil portion 118. The second portion 112 can be referred to as a ribbon portion 120. The third portion 114 can be referred to as an identification flag portion 122. And, the fourth portion 116 can be referred to as a stranded fiber portion 124. It should be noted that the two ends of the preformed fiber optic circuits may be configured in a similar manner since both ends are to be terminated to fiber optic connectors. The stranded fiber portion 124 may be located adjacent the middle of the preformed circuit as shown.

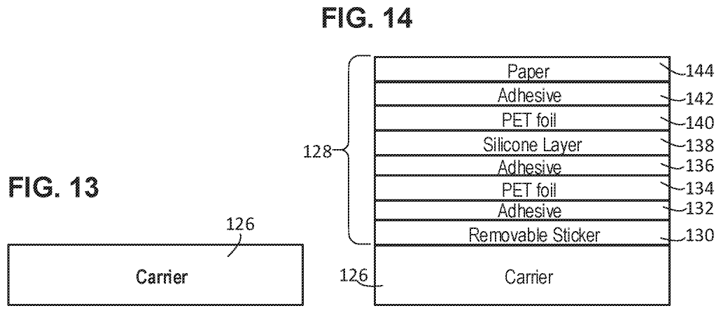

The methods discussed herein with respect to FIGS. 13-24 specifically detail the steps used in preparing the first-fourth portions 110, 112, 114, 116 of the preformed optical circuit 100. Similar steps are applicable to other preformed optical circuits similar in configuration, such as circuit 200.

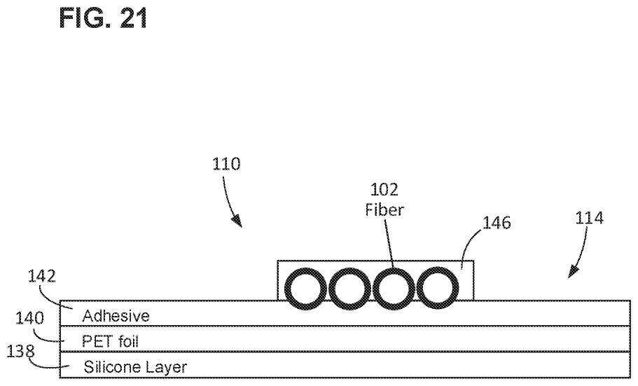

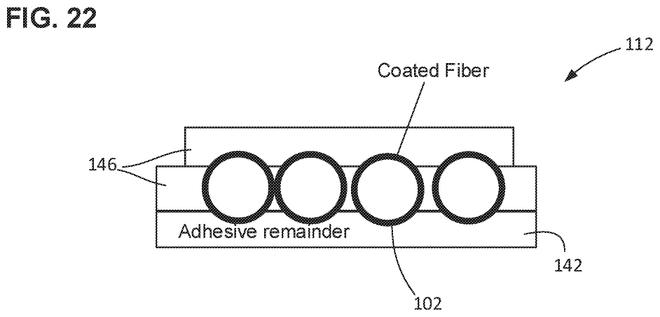

While FIGS. 13-20 specifically detail the methodology used in preparing the different portions of the preformed fiber optic circuit 100, FIG. 21 specifically illustrates the final configuration of the first portion 110 and the third portion 114 of the preformed fiber optic circuit 100. FIG. 22 specifically illustrates the final configuration of the second portion 112 of the preformed fiber optic circuit 100. And, FIG. 24 specifically illustrates the final configuration of the fourth portion 116 of the preformed fiber optic circuit 100, wherein the stranded fibers 102 are removed from a flexible foil layer 140 and are left as bare fibers 102.

As will be described in further detail below, according to one example embodiment, the flexible foil layer 140 for supporting the fibers 102 may be formed from polyethylene terephthalate (PET). However, it should be understood that PET is simply one non-limiting example polymer that may be used to form the flexible foil of the present disclosure, and other polymers having similar characteristics and that are able to at least semi-rigidly support the fibers in a predetermined orientation are also usable in accordance with the inventive concepts of the present disclosure.

After the preformed fiber circuits 100, 200 of FIGS. 7-9 and 10-12 are prepared in accordance with the methods outlined in FIGS. 13-20, the flex foil portion 118 of the circuit 100/200 is completely removed by a cut that is made at the ribbon portion 120 of the circuit 100/200 between the identification flag portion 122 and the flex foil portion 118. Once the ends of the fibers 102 are prepared at the ribbon portion 120 by cleaving and polishing, the ends are ready to be terminated to a fiber optic connector. The identification flag portion 122 may be left in place as a marker in correctly orienting the fibers 102 from one end of a piece of equipment to an opposite end. The stranded fiber portion 124 is also left as a bare fiber 102. Both of the opposing ends of the preformed fiber optic circuit 100/200 are processed in the same manner as just described.

It should be noted that in certain instances, instead of termination to the ferrules of the fiber optic connectors, the ribbon portion 120 (or even the stranded fiber portion 124) may be connected to other ribbons or connector (multi-fiber/simplex) stub fibers via a splicing operation.

Now referring to FIGS. 13-24, the preparation of the exemplary preformed fiber optic circuits 100/200, including the four different portions 110, 112, 114, 116 is detailed herein.

Referring specifically to FIG. 13, a carrier 126 is used to initially support the preformed fiber circuit 100 (or 200) of the present disclosure. According to one example embodiment, the carrier 126 may be a plate with a siliconized top layer and may be provided as part of a piece of equipment or machine that is conventionally used in forming flexible fiber optic circuits.

Referring to FIG. 14, as seen in the diagrammatic view, a substrate 128 including two layers of flexible foil (e.g., PET foil) is provided for initially supporting the preformed fiber optic circuit 100. The two layers of PET foil are stacked and separated by adhesives.

As seen in FIG. 14, when viewed at a transverse cross-section, starting from the bottom carrier 126, the substrate 128 includes a removable sticker layer 130, a first adhesive layer 132, a first layer of PET foil 134, a second adhesive layer 136, a silicone layer 138, a second layer of PET foil 140, a third adhesive layer 142, and a final paper layer 144.

According to example embodiments, the removable sticker layer 130 may be a polyethylene copolymer (PE) layer with an adhesive coating for removability from the carrier 126. In certain embodiments, the removable sticker 130 may have a thickness of around 0.07 millimeters (mm).

The first layer of PET foil 134, as seen, is surrounded by the two adhesive layers 132, 136. The second layer of PET foil 140 may be around 0.05 mm in thickness and have a siliconized side 138 to facilitate release. The third adhesive layer 142 that is on the second layer of PET foil 140 may be an acrylic 200MP adhesive having a thickness of around 0.13 mm. The top paper layer 144 may be a Polycoated Kraft Paper (PCK) having a thickness of around 0.11 mm.

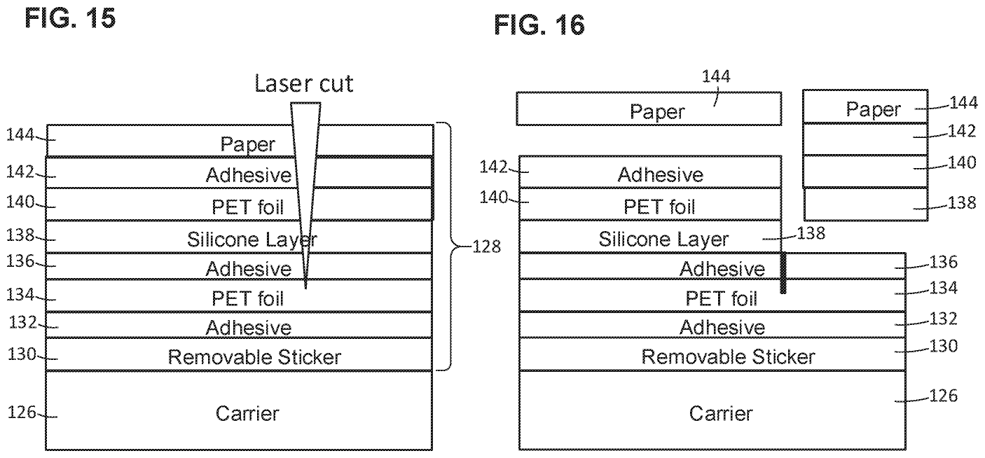

Now referring to FIG. 15, as the next step in the process, a pattern is cut into the top PET foil layer 140 with, for example, a CO₂ laser. The cut may extend to the first PET foil layer 134 as shown in FIG. 15. It should be noted that the minimum cut depth preferably extends past the siliconized side 138 of the top PET foil layer 140 to the second adhesive layer 136. And, the maximum cut depth preferably extends past the adhesive 132 at the underside of the first PET foil 134 to the removable sticker layer 130.

As will be described in further detail, the minimum cut depth is set for facilitating removal or peeling of the top PET foil layer 140 for preparing the preformed fiber optic circuit 100 of the present disclosure. The maximum cut depth is set for facilitating removal or peeling of the lower PET foil layer 134 and sticker 130 from the reusable carrier 126, where the lower PET foil layer 134 and the sticker 130 are discharged, as will be discussed.

Referring now to FIG. 16, the laser-cut top PET foil layer 140 portions (including the silicone layer 138, the top PET foil layer 140, the third adhesive layer 142, and the paper layer 144) are removed. The uncut portions remain on the substrate 128 as shown. The top paper layer 144 is removed from the entire substrate 128 leaving exposed the third adhesive layer 142 as the top layer on the remaining substrate 128.

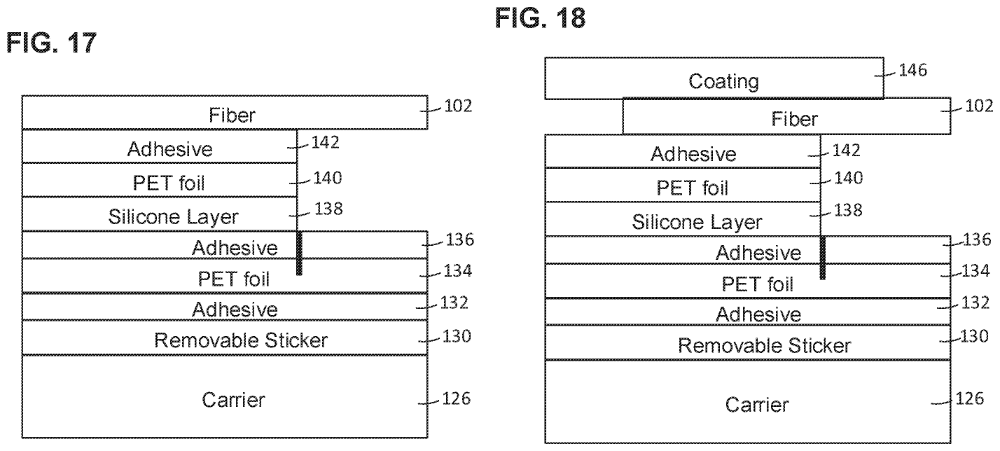

Referring now to FIG. 17, optical fibers 102 (e.g., 0.25 mm fibers) are routed onto the substrate 128 and are held in place by the top adhesive layer 142 and the second adhesive layer 136.

Referring now to FIG. 18, an optional conformal silicone coating 146 may be applied to the fibers 102 at the desired portions of the circuit as will be discussed in further detail below. The silicone coating 146, where applied, is used to supplement the top adhesive layer 142 to fix the fibers 102 onto the top PET foil 140 and to cover the top adhesive layer 142 to limit tackiness.

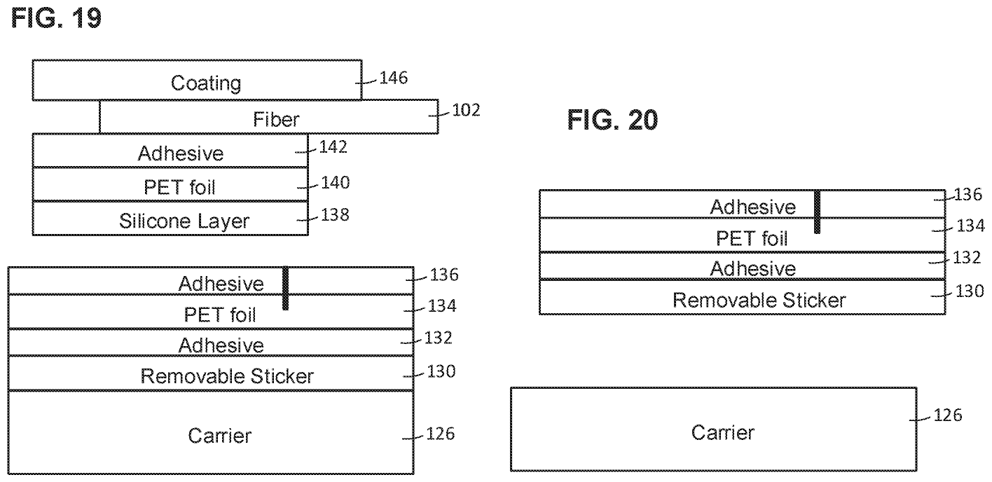

Referring now to FIG. 19, as the next step, the fibers 102 with the top PET foil layer 140 and the silicone coating 146 (if applied) are removed or peeled from the carrier 126 and may form a portion of the preformed fiber optic circuit of the present disclosure.

Referring to FIG. 20, the bottom PET foil layer 134 surrounded by the first and second adhesive layers 132, 136 and the removable sticker layer 130 are removed from the carrier 126 and discarded. As noted above, the carrier 126 with the siliconized surface may be part of a piece of machine or equipment and may be reusable for this process.

FIG. 21 specifically illustrates the final configuration of the first portion 110 and the third portion 114 of the preformed fiber optic circuit 100. As noted previously, the first portion 110 can be referred to as the flex foil portion 118 and the third portion 114 can be referred to as the identification flag portion 122. These first and third portions 110, 114 are illustrated in the preformed fiber optic circuits 100, 200 of FIGS. 7 and 10. The flex foil portion 118 and the identification flag portion 122 both include the silicone coated fibers 102 that are supported by the top PET foil layer 140, wherein the third adhesive layer 142 and the silicone layer 138 surround opposite sides of the PET foil layer 140.

FIG. 22 specifically illustrates the final configuration of the second portion 112 of the preformed fiber optic circuit 100. As noted previously, the second portion 112 can be referred to as the ribbon portion 120. The ribbon portion 120 includes the silicone coated fibers 102 with the remaining top adhesive layer 142. The silicone coating 146 may interact with the adhesive layer 142, and the combination may result in a layer having a thickness of around 0.15-0.20 mm. As shown, the ribbon portion 120 does not include the top PET foil layer 140, which is removed in the process. This process provides a unique and novel method of forming ribbonized fiber.

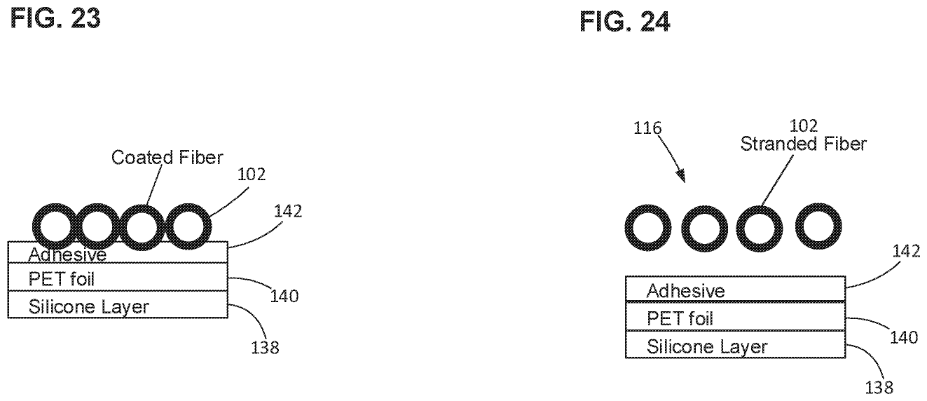

FIGS. 23-24 specifically illustrate the formation of the bare stranded fiber portion 124, also referred to as the fourth portion 116 of the preformed fiber optic circuit 100. The stranded fiber portion 124 starts out with fibers 102 that are routed onto the substrate 128 and are held in place by the top adhesive layer 142 and the second adhesive layer 136. However, unlike the first and third portions 110, 114 of the optical circuit 100, the silicone coating 146 that is shown in the step illustrated in FIG. 18 is not applied. FIG. 23, thus, illustrates the bare fiber 102 with the top PET foil layer 140 (along with the top adhesive layer 142 and the silicone layer 138 at the bottom of the top PET layer 140) that has been removed or peeled from the carrier 126. And, FIG. 24 illustrates the removal of the bare fiber 102 from the adhesive 142 holding the fiber 102 to the top PET foil layer 140 to form the stranded fiber portion 124 of the preformed optical circuit 100.

It should be noted that the process described herein allows the stranded fibers 102 that had been routed in a predetermined configuration on the substrate 128 to maintain their initial configuration, including any fibers 102 that are crossed-over as they extend from one end of the circuit to the opposite end (as shown in the circuits 100, 200 of FIGS. 7-12).

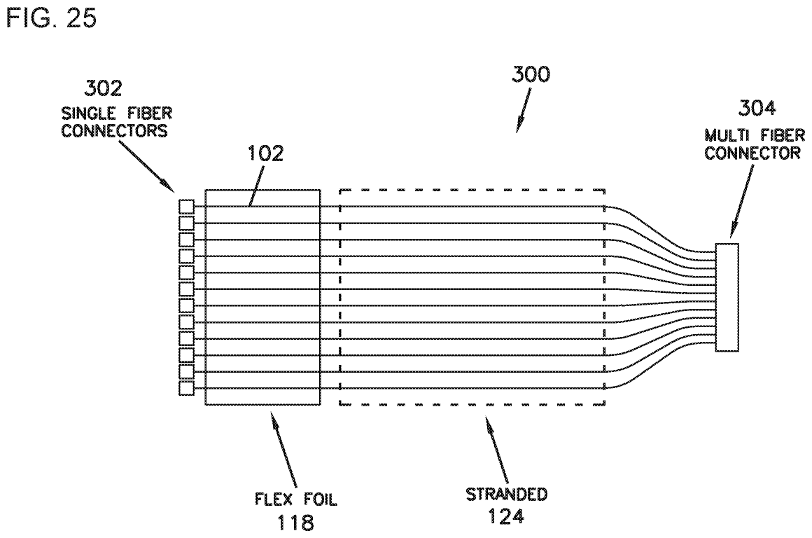

Now referring to FIG. 25, illustrated therein is a hybrid type fiber optic circuit 300 prepared in accordance with the methods of FIGS. 13-20, wherein the hybrid circuit 300 includes both a flex foil portion 118 and a stranded fiber portion 124, wherein the flex foil portion 118 is not necessarily used for identification purposes, but is used to fix the fibers 102 in the predetermined orientation.

In the illustrated fully terminated fiber optic circuit 300, the first ends of the fibers 102 of the circuit 300 are terminated to simplex fiber optic connectors 302 (e.g., LC connectors) and second ends of the fibers 102 of the circuit are terminated to a multi-fiber connector 304. The portion 118 of the hybrid fiber optic circuit 300 adjacent the simplex fiber optic connectors 302 includes a plurality of fibers 102 in a predetermined arrangement supported by a flex foil (e.g., a layer of PET foil 140 and coated by a silicone coating 146), and the portion 124 of the fiber optic circuit 300 adjacent the multi-fiber connector 304 includes a plurality of uncoated bare stranded fibers 102 in a predetermined arrangement. Such a hybrid fiber optic circuit may provide the precision needed at the first end of the circuit 300 with the flex foil, where the fibers are individually terminated to the simplex fiber optic connectors 302 and may provide some flexibility at the second end of the circuit 300, where the bare fibers may have to be manipulated or re-worked in terminating to the multi-fiber connector 304.

Having described the preferred aspects and embodiments of the present disclosure, modifications and equivalents of the disclosed concepts may readily occur to one skilled in the art. However, it is intended that such modifications and equivalents be included within the scope of the claims which are appended hereto. And, although in the foregoing description, terms such as “top,” “bottom,” “front,” “back,” “right,” “left,” “upper,” and “lower” may have been used for ease of description and illustration, no restriction is intended by such use of the terms. The telecommunications devices described herein can be used in any orientation, depending upon the desired application.

1. A method of preparing a fiber optic circuit, the method comprising:
providing a substrate for supporting a plurality of optical fibers, the substrate including at least one layer of flexible foil formed from polyethylene terephthalate (PET);
peeling a layer including the plurality of optical fibers from the at least one layer of flexible foil, wherein the substrate includes two layers of PET foil, the two layers including an upper layer of PET foil that supports the plurality of optical fibers peeled off from a lower layer of PET foil, wherein the two layers of PET foil are initially bonded via an adhesive before peeling the upper layer off from the lower layer; and
terminating one end of the optical fibers supported by the upper layer of PET foil to a multi-fiber connector.

2. (canceled)

3. A method according to claim 1, wherein the peeled layer also includes at least a portion coated with a coating including silicone.

4. A method according to claim 1, wherein the peeled layer includes at least a portion of only bare optical fibers that are not coated with a coating that includes silicone.

5-7. (canceled)

8. A method according to claim 1, wherein the peeled layer including a layer of PET foil is used as an identification flag defining indicia for orienting the optical fibers in a correct orientation prior to termination to any fiber optic connectors.

9. A method according to claim 1, wherein the substrate includes the two layers of PET foil, the two layers including the upper layer of PET foil that supports the optical fibers peeled off from the lower layer of PET foil that is also peeled from a carrier plate, wherein the lower layer of PET foil is discarded.

10-11. (canceled)

12. A preformed fiber optic circuit that is configured for termination to at least one fiber optic connector, the preformed fiber optic circuit comprising:
a plurality of optical fibers arranged in a predetermined arrangement, wherein at least a portion of the optical fibers are supported by a layer of flexible foil formed from polyethylene terephthalate (PET) and at least a portion are coated by a coating including silicone, wherein the plurality of optical fibers also includes at least a portion not supported by a flexible foil and not coated by a coating including silicone, wherein said plurality of optical fibers that are not supported by a flexible foil and not coated by a coating including silicone are bare fibers, wherein the portion of the optical fibers coated by the coating including silicone at least partially overlaps the portion supported by the flexible foil.

13-16. (canceled)

17. A preformed fiber optic circuit according to claim 12, wherein the portion of the optical fibers coated by the coating including silicone that at least partially overlaps the portion supported by the layer of flexible foil is used as an identification flag defining indicia for orienting the fibers in a correct orientation prior to termination to the at least one fiber optic connector.

18. A preformed fiber optic circuit according to claim 12, wherein one end of the optical fibers are terminated by a multi-fiber connector.

19. A preformed fiber optic circuit according to claim 12, wherein one end of each optical fiber is terminated with a simplex fiber optic connector.

20. (canceled)

21. A preformed fiber optic circuit according to claim 12, wherein one end of each optical fiber is terminated to a multi-fiber connector and opposite ends are connected to simplex connectors.

22. A preformed fiber optic circuit according to claim 12, wherein the portion of the optical fibers supported by the layer of flexible foil also includes an adhesive between the fibers and the layer of flexible foil.

23-32. (canceled)

33. A fiber optic circuit comprising:
a first plurality of optical fibers that connect between a plurality of multi-fiber connectors at one portion of the fiber optic circuit and a lesser number of multi-fiber connectors at another portion of the fiber optic circuit; and
a second plurality of optical fibers that only connect to at least one of the multi-fiber connectors at the one portion and are dark fibers, wherein the multi-fiber connectors provided at the one portion of the fiber optic circuit do not use all fiber signal paths for transmitting signals and include some dark fibers, and the lesser number of the multi-fiber connectors provided at the another portion of the fiber optic circuit use all of the fiber signal paths for transmitting signals,
wherein the fiber optic circuit is formed by initially providing a substrate including at least one layer of flexible foil formed from polyethylene terephthalate (PET) for supporting at least some of the optical fibers, wherein the at least one layer of flexible foil formed from PET is peeled from at least some of the optical fibers, wherein the optical fibers separated from the flexible foil formed from PET includes at least a portion coated with a coating including silicone.

34. A fiber optic circuit according to claim 33, wherein the optical fibers separated from the flexible foil formed from PET includes at least a portion of only bare optical fibers that are not coated with a coating that includes silicone.

35. A fiber optic circuit according to claim 33, further comprising indicia for orienting the optical fibers in a correct orientation prior to termination to one of the multi-fiber connectors.

36. A fiber optic circuit according to claim 35, wherein the indicia provided on the fiber optic circuit is also configured to visually indicate the multi-fiber connector to which the optical fibers are to be terminated.

37. A fiber optic circuit according to claim 33, wherein the multi-fiber connectors provided at the one portion of the fiber optic circuit each include at least one row of twelve fibers and the lesser number of the multi-fiber connectors provided at the another portion of the fiber optic circuit each include at least one row of twelve fibers.

38. A fiber optic circuit according to claim 33, wherein the fiber optic circuit is provided within a telecommunications cassette.

39. A fiber optic circuit according to claim 38, wherein the multi-fiber connectors provided at the one portion of the fiber optic circuit and the lesser number of the multi-fiber connectors provided at the another portion of the fiber optic circuit are connected to fiber optic adapters that are provided as part of a body of the cassette.
